(19) United States
(12) Patent Application Publication
(10) Pub. No.: US 2011/0119170 A1
(43) Pub. Date: May 19, 2011

(54) SYSTEM AND METHOD FOR PERFORMING AN OPENING AUCTION OF A DERIVATIVE

(75) Inventors: Thomas WINTER, Frankfurt (DE); Mark RUDEL, Friedberg (DE); Helmut LALLA, Muhlheim (DE); Stefan BRENDGEN, Villmar (DE); Bjöm Geißler, Weiterstadt (DE); Alexander MARTIN, Modautal (DE); Antonio MORSI, Morfelden-Walldorf (DE)

(73) Assignee: Deutsche Borse AG, Frankfurt/Main (DE)

(21) Appl. No.: 12/618,410

(22) Filed: Nov. 13, 2009

(51) Int. Cl. G06Q 40/00; G06Q 10/00

(52) U.S. Cl. 705/37

(57) ABSTRACT

A computer system performs an opening auction of a derivative such as a financial futures. The computer system comprises an order maintenance module and an optimizing module. The order maintenance module maintains a plurality of order books for said derivative. The plurality of order books comprises a first set of order books and a second set of order books. Each order book of the first set of order books comprises bid and ask orders for a specific tradable series of the derivative. Each order book of the second set of order books comprises bid and ask orders for a specific combination of two tradable series of the derivative. Each bid and ask order is associated with an integer volume of tradable contracts of the derivative. The optimizing module maximizes a total volume of executed contracts using integer optimization to determine opening prices for the tradable series of the derivative.

### BACKGROUND OF THE INVENTION

1. Field of the Invention

The invention relates to a computer system and a computer-implemented method for automatically performing an opening auction of a derivative and, more particularly, performing an opening auction of futures to determine an opening price for the continuous trade.

2. Description of the Related Art

In the last 20 years, derivatives such as futures or options have become increasingly important in the world of finance. Futures and options are now traded actively on many exchanges throughout the world. A derivative can be defined as a financial instrument whose value depends on or derives from the values of other, more basic underlying variables. Very often, the variables underlying derivatives are the prices of traded assets. A stock option, for example, is a derivative whose value is dependent on the price of a stock.

A futures contract is an agreement between two parties to buy or sell an asset at a certain time in the future for a certain price. Unlike forward contracts, futures contracts are normally traded on an exchange such as the Eurex.

A derivative exchange is a market where individuals trade standardized contracts that have been defined by the exchange. Traditionally, derivatives traders have met on the floor of an exchange and used shouting and a complicated set of hand signals to indicate the trades they would like to carry out. This is known as the open outcry system. In recent years, exchanges have increasingly moved from the open outcry system to electronic trading.

Generally there are many different kinds of futures contracts, reflecting the many different kinds of tradable assets on which the contract may be based. Tradable assets may be, for instance, commodities, securities such as stocks, currencies or intangibles such as interest rates and indexes. Futures on stocks, currencies or indexes are also called financial futures.

Every trading day, before starting the continuous trading of derivatives, the opening price of each tradable series of a derivative is determined in an opening auction. Conventional opening auctions, however, may result in an inconsistent opening price for a tradable series of a derivative.

### SUMMARY OF THE INVENTION

In an embodiment, a computer system performs an opening auction of a derivative. The computer system comprises an order maintenance module and an optimizing module. The order maintenance module is configured to maintain a plurality of order books for said derivative. The plurality of order books comprises a first set of order books and a second set of order books. Each order book of the first set of order books comprises bid and ask orders for a specific tradable series of the derivative. Each order book of the second set of order books is a combination order book, wherein each combination order book comprises bid and ask orders for a specific combination of two tradable series of the derivative. A combination of two tradable series may be defined as the simultaneous purchase of one specific tradable series and the sale of another tradable series of said derivative. Each bid and ask order is associated with an integer volume of tradable contracts of the derivative. The optimizing module is operatively coupled to the order maintenance module. The optimizing module is configured to maximize a total volume of executed contracts using integer optimization, wherein the total volume of executed contracts is the sum of the integer volumes associated with contracts executed in said plurality of order books.

In another embodiment, a computer-implemented method for performing an opening auction of a derivative is provided. An order maintenance module of a computer system receives a first and a second order book, wherein the first order book comprises bid orders and ask orders for a first tradable series of said derivative and wherein the second order book comprises bid orders and ask orders for a second tradable series of said derivative. The order maintenance module also receives a third order book. The third order book comprises bid orders for the first tradable series combined with ask orders for the second tradable series. Each of the bid orders and each of the ask orders in each of the first, second and third order book is associated with an integer volume of tradable contracts of said derivative. A pre-processing module of the computer system calculates for each of the first, second and third order book an upper bound for the volume of executable contracts associated with bid orders. The pre-processing module also calculates for each of the first, second and third order book an upper bound for the volume of executable contracts associated with ask orders. The pre-processing module then provides modified first, second and third order books by cancelling, for each order book, bid orders based on the calculated upper bound for the volume of executable contracts associated with bid orders of the respective order book and cancelling, for each order book, ask orders based on the calculated upper bound for the volume of executable contracts associated with ask orders of the respective order book. The modified first, second and third order books are provided to an optimizing module of the computer system. The optimizing module determines an opening price of each of the first and second tradable series of the derivative using the modified first, second and third order books.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1a schematically illustrates the formation of price levels in an order book according to an embodiment;

FIG. 1b illustrates an exemplary order book according to an embodiment;

FIG. 2 shows a digraph illustrating matching paths of tradable futures series according to an embodiment;

FIG. 3 illustrates an exemplary system for performing an opening auction of derivatives according to an embodiment; and

FIG. 4 illustrates steps of a method for performing an opening auction of a derivative according to an embodiment.

### DETAILED DESCRIPTION OF THE INVENTION

The illustrative embodiments of the present invention will be described with reference to the figure drawings, wherein like elements and structures are indicated by like reference numbers.

Systems and methods of the present invention may determine a consistent opening price of tradable series of a derivative. Derivatives may be options or futures on certain assets. In the following, many embodiments of the invention are described with regard to futures in more detail. A futures contract is a binding obligation enforceable at law to buy or sell a stated quantity of a specified asset on a specified date in the future at a predetermined price. However, the skilled person may appreciate that the principles of the present invention may also be applicable to other derivatives such as options or swaps.

According to embodiments of the present invention, derivatives traded on an exchange such as the Eurex may be associated with several expiration dates per year. For instance, futures traded on the Eurex may have four expiration dates per year: in March, in June, in September and in December. Each expiration date is associated with a series of the derivative.

Only certain series of a derivative may be tradable. For financial futures, for example, only the three series of the financial futures which have expiration dates closest to the date of the current trading day may be tradable. Combinations of tradable series may also be tradable.

Combinations (also referred to as combination orders, derivative combinations or derivative combination orders) are bid orders for a first tradable series of a derivative combined with ask orders of a second tradable series of the derivative. Thus, a combination of two tradable series may be defined as the simultaneous purchase of one specific tradable series and the sale of another tradable series of said derivative. The expiration date of the first tradable series may be prior to the expiration date of the second tradable series. Although embodiments of the present invention describe that the expiration date of the tradable series associated with the bid order is prior to the expiration date of the tradable series associated with the ask order in derivative combination orders, embodiments may exist where the expiration date of the tradable series associated with the ask order is prior to the expiration date of the tradable series associated with the bid order in derivative combination orders.

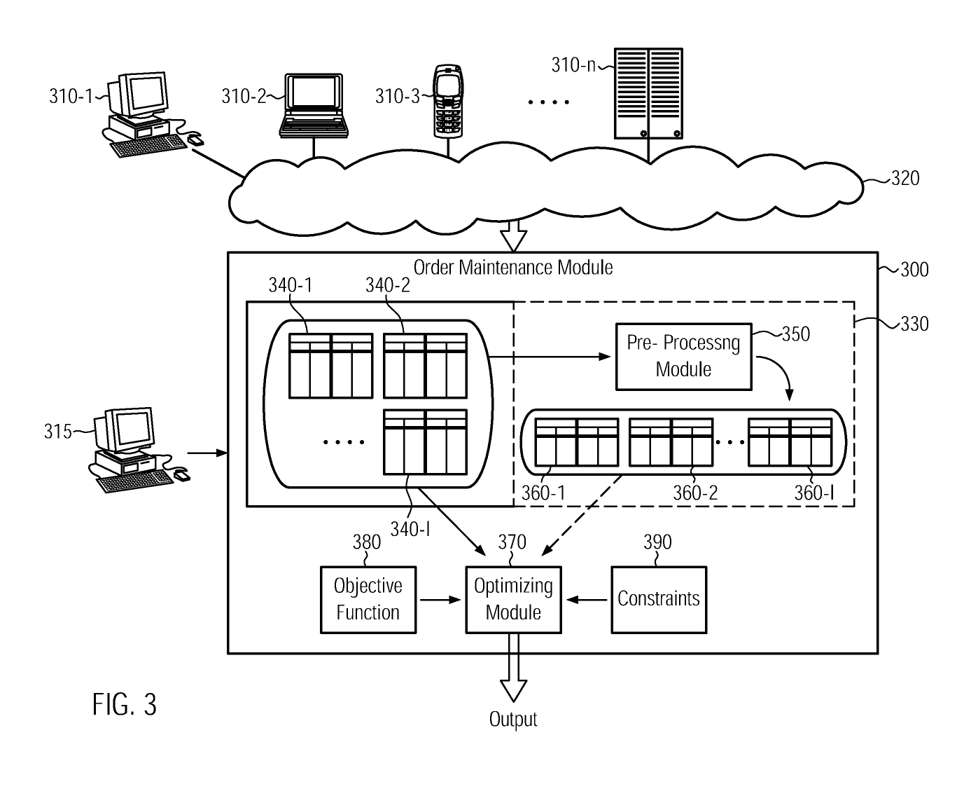

When using an electronic trading system, both the orders for tradable series of a derivative (such as futures) and the derivative combination orders are stored in order books. Hence, in an electronic trading system of the present invention, such as the system of FIG. 3 described in more detail below, there may be stored six order books per financial futures: One order book for each of the three tradable series and three order books for futures combination orders.

The auction price for a tradable series may always be positive, whereas the price for a combination order may be positive or negative. Specifically, the price for a combination order may be the price of the first tradable series of the combination order minus the price of the second tradable series of the combination order, wherein the first tradable series expires prior to the second tradable series.

A price may be determined after a contract of the futures in an order book has been executed, wherein a contract is the smallest tradable unit of futures.

There may be two different types of orders stored in an order book: Limit orders and market orders. A limit order is an order to buy a series of a derivative (such as futures) or a derivative combination at no more (bid order), or sell a series of a derivative (such as futures) or a derivative combination at no less (ask order) than the limit price. A market order is an order having no limit price to buy or sell a series of a derivative (such as futures). Market orders may have the highest priority in the opening auction, i.e. market orders need to be executed first.

Order books may be stored in electronic trading systems as tables. The left side of such a table may comprise buy orders and the right side may comprise sell orders.

Discussing order books on the example of futures in more detail, for the buy side, contracts of one or more limit orders (bid orders) being associated with the same limit price may be merged into one price level. Similarly, for the sell side, contracts of one or more limit orders (ask orders) being associated with the same limit price may be merged into one price level. Each price level may be associated with a limit price and an integer volume of tradable contracts of the futures for the limit price.

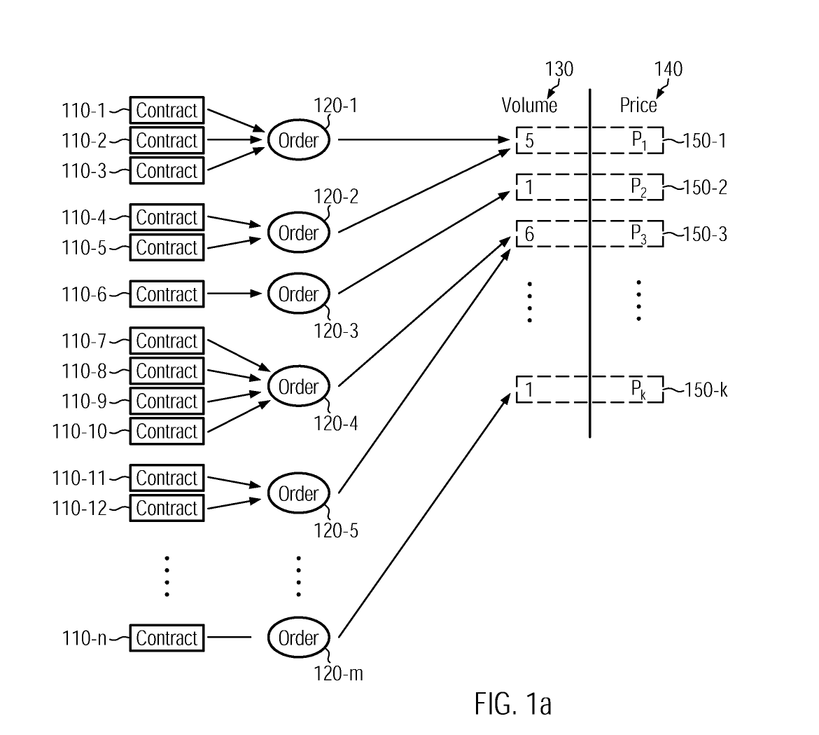

FIG. 1a illustrates the formation of a side (buy or sell) of an order book according to an embodiment of the invention. Each side of an order book may list a volume 130 of contracts and a limit price 140 associated with the volume. As previously stated, a contract is the smallest tradable unit of futures. In the embodiment of FIG. 1a, a first market participant may want to buy (sell) contracts 110-1, 110-2 and 110-3 forming the order 120-1 at no more (at no less) than the price limit p₁. Similarly, a second market participant may want to buy (sell) contracts 110-4, and 110-5 forming the order 120-2 at no more (at no less) than the same price limit p₁. Hence, the two orders may be merged into the price level 150-1 associated with the limit price p₁ and the accumulated integer volume of the contracts 110-1, 110-2, 110-3, 110-4 and 110-5, i.e. 5. The price level 150-2 associated with the limit price p₂ may be built from the order 120-3. As contract 110-6 is the only contract which forms the order 120-3, the price level 150-2 associated with the limit price p₂ has an associated volume of tradable contracts of the futures of 1. In the same manner, the price level 150-3 associated with p₃ and the integer volume of tradable contracts of 6 is built from orders 120-4 and 120-5. Contracts 110-7 to 110-10 form the order 120-4 and contracts 110-11 and 110-12 form the order 120-5. Finally, contract 110-n forms order 120-m which may be merged into the price level 150-k associated with the limit price pₖ and volume 1. The table may store any number of different price levels. For instance, in the example of FIG. 1a, there are k different price levels, m different orders and n contracts, wherein k, m and n are integer numbers.

FIG. 1b illustrates an exemplary order book having three rows prior to the opening auction. The bid side 160 lists buy orders and the ask side 180 lists sell orders, wherein each side has a volume column 170, 180 and a price column 175, 185. The number of different price levels may be referred to as order book depth. In the example of FIG. 1b, both the order book depth of the buy side and the sell side is 3.

Generally, for the bid side, the best-bid (the highest price, a market participant is willing to pay for a certain volume of contracts of the futures) may be merged into the top-most price level. The contracts associated with the lowest price a market participant is willing to pay for a certain volume of contracts of the futures may be merged into the lower-most price level. Thus, the price levels on the buy side (bid side) may be ordered descending with regard to the associated limit prices. For the ask side, on the other hand, the best-ask (the lowest price, a market participant is willing to sell a certain volume of contracts of the futures) may be merged into the top most price level. The contracts associated with the highest price a market participant is willing to sell a certain volume of contracts of the futures may be merged into the lower-most price level. Accordingly, the price levels on the sell side (ask side) may be ordered ascending with regard to the associated limit prices.

An order book is a crossed order book, if the best-bid is greater than or equal to the best-ask. If the order book is crossed, bid-orders and ask-orders need to be executed against each other as long as possible. The mutual execution of bid-orders and ask-orders is also referred to as matching. In the example of FIG. 1a, the best-bid of (100) is greater than the best-ask of (91). Hence, the exemplary order book of FIG. 1b is crossed and needs to be un-crossed in an opening auction.

For futures, at the beginning of a trading day, the order books may be opened for a certain period of time. During that period, market participants may submit new orders for a specific tradable series of futures or futures combination and may also alter existing orders in the order books. This phase is also referred to as pre-trading. Then, the order books are closed and the opening auction for the futures may be performed. Hence, for the opening auction, firstly, the orders may be collected and stored in the order books and then, secondly, the order books may be un-crossed. This results in a price for each tradable series of futures, i.e. the opening price. The opening price is the first price for the continuous trade of the futures which follows the opening auction.

As previously stated, the execution of contracts of the buy or sell side of one or more order books may also be referred to as matching. A matching within an order book is called direct matching. If contracts of more than one order book are executed, the process is called synthetic matching. During direct matching, the executed volume of contracts of the buy side of a specific order book equals the executed volume of contracts of the sell side of this specific order book. For synthetic matching, the executed volume of contracts of the buy side differs from the executed volume of the sell side in order books for the tradable series of the futures due to the involvement of order books for futures combinations.

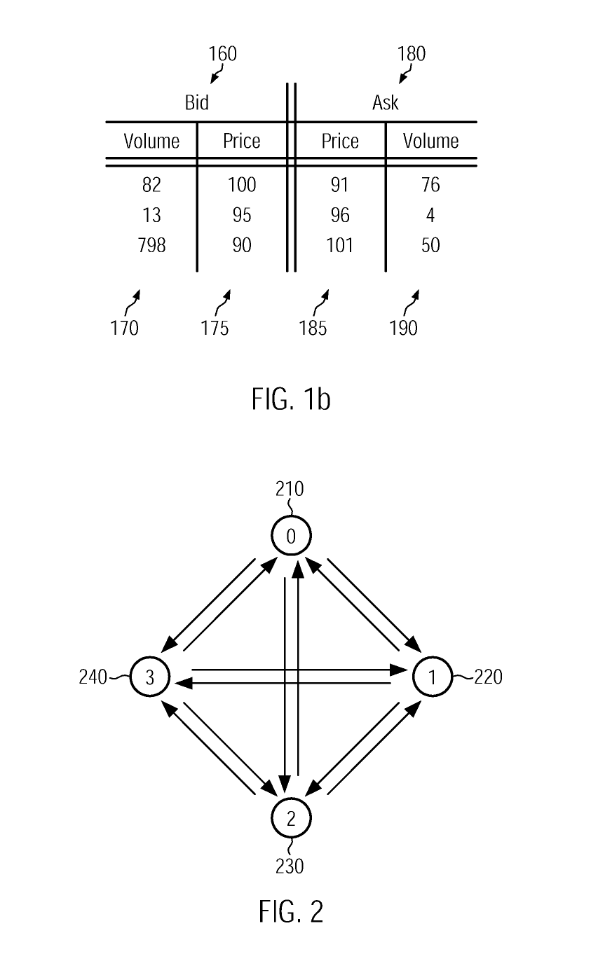

Referring now to FIG. 2, each of the nodes 210, 220, 230 and 240 is labelled with a number. Nodes 220, 230 and 240 are labelled with 1, 2 and 3 to indicate that they represent tradable series 1, 2 and 3, respectively, of futures. Node 210 is labelled with 0 to indicate that this node does not represent any tradable series of futures. Tradable series 1 may be associated with an expiration date nearest to the date of a current trading day, tradable series 3 may be associated with an expiration date farthest from the date of the current trading day. The expiration date of tradable series 2 may lie in between.

A directed edge from a first node to a second node means to buy the tradable series of the futures represented by the first node and to concurrently sell the tradable series of the futures represented by the second node. A directed edge from node 210 to node 220, 230 or 240 means to buy nothing and to concurrently sell the series represented by node 220, 230 or 240, respectively. This corresponds to a sell order for the tradable series 1, 2 or 3, respectively. Similarly, a directed edge from node 220, 230 or 240 to node 210 means to buy a tradable series represented by node 220, 230 or 240, respectively, and to sell nothing. This corresponds to a buy order for the tradable series 1, 2 or 3, respectively. Matching paths (representing a matching) are closed cycles in the digraph of FIG. 2. Hence, there are 20 matching paths in total: 6 for direct matching and 14 for synthetic matching. For the example of FIG. 2, the 20 matching paths are:

| | |
|---|---|
| 1. | ((1,0), (0,1)) |
| 2. | ((2,0), (0,2)) |
| 3. | ((3,0), (0,3)) |
| 4. | ((1,2), (2,1)) |
| 5. | ((1,3), (3,1)) |
| 6. | ((2,3), (3,2)) |
| 7. | ((0,1), (1,2), (2,0)) |
| 8. | ((0,1), (1,3), (3,0)) |
| 9. | ((0,2), (2,1), (1,0)) |
| 10. | ((0,2), (2,3), (3,0)) |
| 11. | ((0,3), (3,1), (1,0)) |
| 12. | ((0,3), (3,2), (2,0)) |
| 13. | ((1,2), (2,3), (3,0)) |
| 14. | ((2,1), (1,3), (3,0)) |
| 15. | ((0,1), (1,2), (2,3), (3,0)) |
| 16. | ((0,1), (1,3), (3,2), (2,0)) |
| 17. | ((0,2), (2,1), (1,3), (3,0)) |
| 18. | ((0,2), (2,3), (3,1), (1,0)) |
| 19. | ((0,3), (3,1), (1,2), (2,0)) |
| 20. | ((0,3), (3,2), (2,1), (1,0)) |

wherein the tuple (i,j) corresponds to the directed edge from the node labelled with i to the node labelled with j.

Conventional opening auctions consider merely the order books for the tradable series. Specifically, conventional systems for performing opening auctions of futures do not take the order books for futures combinations into account. This may result in inconsistent opening prices for the tradable series of futures. A conventional opening auction may be performed according to the following rules:
1) The executed volume for the determined price is maximal;
2) the auction price needs to equal a limit price in one of the order books;
3) after the opening auction, the best-bid is less than or equal to the auction price and the best-ask is greater than or equal to the auction price and the best-ask is not equal to the best-bid; and
4) the auction price is the highest price satisfying rules 1) to 3).

The auction price at the end of the opening auction may be the determined opening price for the continuous trade.

Rules 1) to 4) guarantee a consistent auction price. In conventional electronic systems for performing an opening auction, an auction price cannot be determined if:
a) at least one side of at least one order book is empty;
b) an order book comprises merely market orders; and
c) an order book is not crossed and there are no market orders in the order book.

Referring now to FIG. 3, an exemplary computer system 300 for performing an opening auction of a derivative such as futures according to an embodiment of the present invention is described. The present invention may be operational with numerous general purpose or special purpose computing system environments or configurations. Examples of well known computing systems, environments, and/or configurations that may be suitable for use with the invention may include, but are not limited to, personal computers, server computers, hand-held or laptop devices, multiprocessor systems, microprocessor-based systems, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The general purpose or special purpose computing system environments or configurations may be programmable using a high-level computer programming language. In some embodiments, the general purpose or special purpose computing system environments or configurations may also use specially-programmed, special-purpose hardware.

The invention may also be practiced in distributed computing environments where tasks are performed by remote processing devices that are linked through a communication network. In a distributed computing environment, program modules may be located in both local and remote computer storage media including memory storage devices.

The computer system 300 may comprise an order maintenance module 330, an optimizing module 370 and repositories 380 and 390. The order maintenance module 330 is configured to store order books 340-1, 340-2 to 340-I for derivatives such as futures or options, wherein I is an integer number. The order books may be stored as tables in a format described with respect to FIG. 1a and FIG. 1b. The skilled person may appreciate that the order maintenance module 330 may store any number of order books for derivatives. For instance, for futures, six order books (three for tradable series and three for futures combination orders) for each futures may be stored in the order maintenance module 330.

The computer system 300 may be coupled via a network 320 such as a WAN, MAN or LAN to a plurality of input devices 310-1, 310-2, 310-3 to 310-n. The input devices may comprise general purpose or special purpose computer systems 310-1, laptops 310-2, handheld devices 310-3 such as cell phones or PDAs, server systems 310-n and any other computing device. The computing system 300 may also be directly coupled to input terminals 315. Market participants may input orders for tradable series of derivatives or derivative combinations into input devices 310-1, 310-2, 310-3, 310-n and 315 for submission to the computer system 300.

The order maintenance module 330 of computer system 300 receives the input orders for derivatives and derivative combinations and stores the orders in respective order books for the respective derivative. Optimizing module 370 is operatively coupled to the order maintenance module 330 and has access to the order books 340-1, 340-2 to 340-I. The optimizing module 370 is configured to perform opening auctions for derivatives to determine and output opening prices for tradable series of derivatives.

Of course, the computer system 300 may be configured to determine opening prices for tradable series of different derivatives concurrently. However, for purposes of illustration, the principles of the present invention are described for performing an opening auction for tradable series of one derivative in the following.

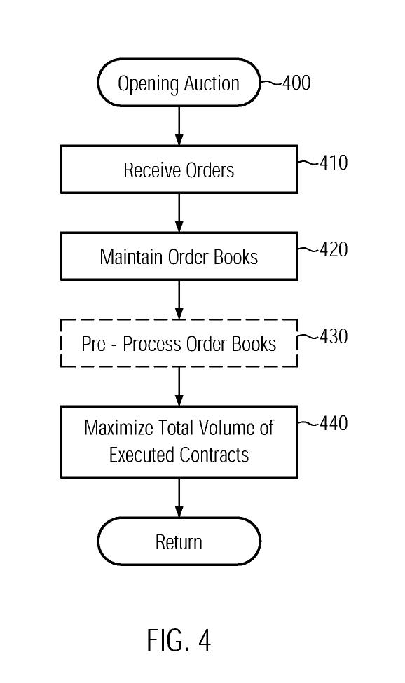

Referring to FIG. 3 and FIG. 4, the computer system 300 receives in step 410 orders for tradable series of a derivative and derivative combinations from market participants via input devices 310-1, 310-2, 310-3, 310-n and 315. The order maintenance module 330 of the computer system 300 may maintain in step 420 the order books 340-1, 340-2 to 340-I for the derivative. Hence, the order maintenance module may store new orders for the derivative in the respective order book or may alter existing orders stored in the order books according to inputs received from the input devices 310-1, 310-2, 310-3, 310-n and 315. The order books 340-1, 340-2 to 340-I comprise at least two order books for tradable series of the derivative and one order book for derivative combination orders. For instance, order book 340-1 may comprise orders for a first tradable series of the derivative, order book 340-2 may comprise orders for a second tradable series of the derivative and order book 340-I may comprise bid orders of the first tradable series combined with ask orders of the second tradable series. In some embodiments, order book 340-I may comprise additionally or alternatively bid orders for the second tradable series of the derivative combined with ask orders for the first tradable series of the derivative. As described above, each tradable series of the derivative may be associated with an expiration date.

In some embodiments, the order maintenance module 330 further comprises a pre-processing module 350. In short, pre-processing module 350 is configured to reduce the size of order books 340-1, 340-2 to 340-I in step 430 to provide modified order books 360-1, 360-2 to 360-I. This will be described in more detail below.

At step 440, the optimizing module 370 determines an opening price for each tradable series of the derivative using order books 340-1, 340-2 to 340-I or 360-1, 360-2 to 360-I by performing an opening auction. Specifically, optimizing module 370 is configured to maximize a total volume of executed contracts using integer programming, also referred to as integer optimization. The total volume of executed contracts may be the sum of the integer volumes associated with contracts executed in order books 340-1, 340-2 to 340-I or 360-1, 360-2 to 360-I in the opening auction.

In mathematics, programming or optimization generally means to solve a problem in which one seeks to minimize or maximize a real function by systematically choosing the values of real variables from within an allowed set. More generally, it means finding best available values of an objective function given a defined domain. For integer programming, some or all variables are constrained to take on integer values. The optimizing module 370 may use any known computational optimization algorithm and commercially available solver to maximize the total volume of executed contracts.

Each tradable derivative may be associated with a ticksize. A market's ticksize is the minimum amount that the price of the market can change. For example, the EUR futures market has a ticksize of 0.0001, which means that the smallest increment that the price can move from 1.2902, would be up to 1.2903, or down to 1.2901. The ticksize is also known as the minimum price change.

Accordingly, in order to use integer programming, the optimizing module 370 may additionally determine at step 440 a ticksize value for the derivative for which the opening auction is to be performed. Further, the optimizing module 370 may determine for each limit order in the order books 340-1, 340-2 to 340-I or 360-1, 360-2 to 360-I the associated limit price and divide each of the determined limit prices by the ticksize value to obtain integer limit prices. The integer limit prices may be used for the following optimization process, i.e. for maximizing the total volume of executed contracts using integer optimization at step 440.

In some embodiments, the optimizing module 370 is coupled to repositories 380 and 1 5 390: Repository 380 may store an objective function modelling the problem to be optimized, i.e. modelling the total volume of executed contracts in the opening auction. The optimizing module 370 may be configured to maximize the objective function subject to constraints stored in repository 380. The entries in repositories 380 and 390 may be amended via terminal 315 or input devices 310-1, 310-2, 310-3 and 310-n.

The total volume of executed contracts may be maximized by the optimizing module 370 using integer optimization subject to constraints stored in repository 390. The constraints may comprise:
(i) If a limit price of a limit bid order of an order book is greater than the auction price of the respective order book, restricting an execution of the limit bid order to complete execution;
   if a limit price of a limit bid order of an order book is less than the auction price of the respective order book, denying an execution of the limit bid order;
   if a limit price of a limit bid order of an order book is equal to the auction price of the respective order book, permitting a partial execution of the limit bid order or restricting an execution of the limit bid order to complete execution or denying an execution of the limit bid order;
   if a limit price of a limit ask order of an order book is greater than the auction price of the respective order book, denying an execution of the limit ask order;
   if a limit price of a limit ask order of an order book is less than the auction price of the respective order book, restricting an execution of the limit ask order to complete execution; and
   if a limit price of a limit ask order of an order book is equal to the auction price of the respective order book, permitting a partial execution of the limit ask order.
(ii) For each of the tradable series of a derivative, the integer volume of executed contracts associated with bid orders of a tradable series needs to equal the integer volume of executed contracts associated with ask orders of the respective tradable series.
(iii) For each order book, executing market orders before limit orders.
(iv) If at least one contract has been executed in each tradable series and each derivative combination of a matching path, ensuring price consistency between the tradable series and derivative combinations of said matching path.
(v) At the end of the opening auction, none of the order books is a crossed order book.

As already indicated above, in some embodiments, the order maintenance module 330 may further comprise a pre-processing module 350. The pre-processing module 350 may be configured to scale down at step 430 the size of each of the order books 340-1, 340-2 to 340-I to provide modified order book 360-1 derived from order book 340-1, modified order book 360-2 derived from order book 340-2 to modified order book 360-I derived from order book 340-I.

To describe optional step 430 in more detail, at the beginning of an opening auction, there may be many different price levels in each of the order books 340-1, 340-2 to 340-I. This may result in a long runtime of the optimization process performed at step 440 by the optimizing module 370. The pre-processing module 350 may analyze at step 430 the order books 340-1, 340-2 to 340-I to cancel orders from each of the order books 340-1, 340,2 to 340-I which are not relevant for the optimizing process of step 440. This may reduce the runtime of the optimization step 440.

Step 430 may comprise two phases which may be performed iteratively. In phase 1, the pre-processing module 350 may determine for each side of each order book 340-1, 340-2 to 340-I an upper bound for the executable volume of contracts, i.e. a maximal executable volume. The pre-processing module 350 then cancels all price levels from each side of the order books 340-1, 340-2 to 340-I below the price level at which the accumulated volume of the respective side exceeds the respective determined maximum executable volume. In phase 2, the pre-processing module 350 calculates more restrictive intervals for possible auction prices based on price consistencies implied by crossed order books.

To describe phase 1 of step 430 in even greater detail, the pre-processing module 350 may calculate for each order book 340-1, 340-2 to 340-I an upper bound for the volume of executable contracts associated with bid orders and an upper bound for the volume of executable contracts associated with ask orders. Further, the pre-processing module may determine for each order book 340-1, 340-2 to 340-I a respective lower bound for a bid price limit based on the respective calculated upper bound for the volume of executable contracts associated with bid orders. Similarly, the pre-processing module 350 may determine for each order book 340-1, 340-2 to 340-I a respective upper bound for an ask price limit based on the respective calculated upper bound for the volume of executable contracts associated with ask orders. Then, the pre-processing module 350 may cancel all bid orders of the order books 340-1, 340-2 to 340-I associated with a bid price limit less than the respective determined lower bound for the bid price limit of the respective order book. Similarly, the pre-processing module 350 may cancel all ask orders of the order books 340-1, 340-2 to 340-I associated with an ask price limit greater than the respective determined upper bound for the ask price limit of the respective order book.

To describe phase 2 of step 430 in even greater detail, the pre-processing module 350 determines the respective executable volumes of contracts in phase 1 of step 430 without consideration of price consistencies. The pre-processing module 350 may scale the size of order books 340-1, 340-2 to 340-I further down in phase 2 of step 430 by using price dependencies. Price dependencies exist between tradable series of a derivative and derivative combinations for which at least one contract has been executed. The fact that an order book is crossed is a sufficient condition that at least one contract has been executed. Hence, the pre-processing module 350 lowers for each order book 340-1, 340-2 to 340-I the determined upper bound (of phase 1) for an ask price limit based on price consistencies implied by crossed order books and raises for each order book 340-1, 340-2 to 340-I the determined lower bound (of phase 1) for a bid price limit based on price consistencies implied by crossed order books.

As an example and not as a limitation, the principles of the present invention, in particular the principles of step 430 and step 440, are described in the following with regard to futures in even more detail. However, embodiments may exist, wherein the principles of the present invention are applied to other derivatives. Specifically, the principles of the present invention are described in more detail for futures having three order books for tradable series and three order books for futures combination orders as described above. For this discussion, the following parameters and variables are introduced:

Sets:

[symbol] ={0, 1, 2, 3}

is the set of indexes of tradable series 1, 2, and 3 of futures plus 0 as described with respect to FIG. 2.

X={b, a}

is the set of sides of an order book. b represents the bid side and a represents the ask side of the order book.

[symbol] ={1, . . . , 7}

is the set of the seven possible price consistencies of the six order books for the futures (described in more detail below).

The following parameters and variables are valid for all x ε X, for all j,k ε [symbol] where k>j and for all i ε {1, . . . , N_{j,k}^{x}}.

Parameters:

N_{j,k}^{x}

is the order book depth of side x of the order book (j,k).

U_{j,k}

is the lower bound of the auction price of the order book (j,k).

O_{j,k}

is the upper bound of the auction price of the order book (j,k).

Q_{j,k}^{x}(i)

is the accumulated volume of contracts of the i^{th}-price level on side x of the order book (j,k).

M_{0,k}^{x}

is the accumulated volume of contracts of the market orders on side x of the order book (0, k).

L_{j,k}^{x}(i)

is the limit price of the i^{th}-price level on side x of the order book (j,k).

Integer Variables:

p_{j,k}

is the auction price of the order book (j,k).

m_{0,k}^{x}

is the number of executed contracts on side of the order book (j,k) of the order book (j,k).

q_{j,k}^{x}(i)

is the number of executed contracts of the i^{th}-price level on side x of the order book (j,k).

b_{j,k}

is the best-bid of the order book (j,k) after the opening auction.

a_{j,k}

is the best-ask of the order book (j,k) after the opening auction.

Binary Variables:

β_{j,k}^{t,x}(i)

is set to 1 if the limit price is greater than or equal to the auction price.

β_{j,k}^{g,x}(i)

is set to 1 if the limit price is greater than the auction price.

β_{0,k}^{m,x}

is set to 1 if all market orders on side x of the order book (0, k) have been executed.

r_{j,k}

is set to 1 if at least one contract of the order book (j,k)has been executed.

Sₕ

is set to 1 if in each tradable series of the futures and each futures combination of the matching path h, wherein h ε [symbol] at least one contract has been executed.

As previously discussed, the optimizing module 370 may maximize a total volume of executed contracts using integer optimization at step 440. In the example of futures having one order book for each of tradable series 1, 2 and 3 and additionally three order books for futures combination orders, the objective function stored in repository 380 and maximized by optimizing module 370 using integer optimization may be:

$$max [ 2 \cdot {\sum }_{{j , k ∈ G}_{k > j > 0}}^{ } {\sum }_{x ∈ X}^{ } ( {\sum }_{i = 1}^{{N}_{j , k}^{x}} {q}_{j , k}^{x} ( i ) ) + {\sum }_{{k ∈ G}_{k > 0}}^{ } {\sum }_{x ∈ X}^{ } ( {m}_{0 , k}^{x} + {\sum }_{i = 1}^{{N}_{0 , k}^{x}} ( {q}_{0 , k}^{x} ( i ) ) ) ] .$$

Using the above defined variables and parameters, constraints (i) to (v) may be represented as inequalities and equations.

The following inequalities needs to be fulfilled for the auction prices and thus model constraint (i):

p_{0,k}≧L_{0,k}^{b}(i)·(1−β_{j,k}^{t,b}(i))+1

p_{0,k}≦L_{0,k}^{b}(i)+(O_{0,k}−L_{0,k}^{b}(i))·(1−β_{0,k}^{t,b}(i))

p_{j,k}≧L_{j,k}^{b}(i)+(U_{j,k}−L_{j,k}^{b}(i))·β_{j,k}^{t,b}(i)+1

p_{j,k}≦L_{j,k}^{b}(i)+(O_{j,k}−L_{j,k}^{b}(i))·(1−β_{j,k}^{t,b}(i))

p_{0,k}≧L_{0,k}^{b}(i)·(1−β_{j,k}^{g,b}(i))

p_{0,k}≦L_{0,k}^{b}(i)+(O_{0,k}−L_{0,k}^{b}(i))·(1−β_{0,k}^{g,b}(i))−1

p_{j,k}≧L_{j,k}^{b}(i)+(U_{j,k}−L_{j,k}^{b}(i))·β_{j,k}^{g,b}(i)

p_{j,k}≦L_{j,k}^{b}(i)+(O_{j,k}−L_{j,k}^{b}(i))·(1−β_{j,k}^{g,b}(i))−1

p_{0,k}≧L_{0,k}^{a}(i)·β_{0,k}^{t,a}(i)

p_{0.k}≦L_{0.k}^{a}(i)+(O_{0,k}−L_{0,k}^{a}(i))·β_{0,k}^{t,a}(i)−1

p_{j,k}≧L_{j,k}^{a}(i)+(U_{j,k}−L_{j,k}^{a}(i))·(1−β_{j,k}^{t,a}(i))

p_{j,k}≦L_{j,k}^{a}(i)+(O_{j,k}−L_{j,k}^{a}(i))·β_{j,k}^{t,a}(i)−1

p_{0,k}≧L_{0,k}^{a}(i)·β_{0,k}^{g,a}(i)+1

p_{0,k}≦L_{0,k}^{a}(i)+(O_{0,k}−L_{0,k}^{a}(i))·β_{0,k}^{g,a}(i)

p_{j,k}≧L_{j,k}^{a}(i)+(U_{j,k}−L_{j,k}^{a}(i))·(1−β_{j,k}^{g,a}(i))+1

p_{j,k}≦L_{j,k}^{a}(i)+(O_{j,k}−L_{j,k}^{a}(i))·β_{j,k}^{g,a}(i)

The following equations model constraint (ii):

$${m}_{0 , 1}^{b} + {\sum }_{i = 1}^{{N}_{0 , 1}^{b}} {q}_{0 , 1}^{b} ( i ) + {\sum }_{i = 1}^{{N}_{1 , 2}^{b}} {q}_{1 , 2}^{b} ( i ) + {\sum }_{i = 1}^{{N}_{1 , 3}^{b}} {q}_{1 , 3}^{b} ( i ) = {m}_{0 , 1}^{a} + {\sum }_{i = 1}^{{N}_{0 , 1}^{a}} {q}_{0 , 1}^{a} ( i ) + {\sum }_{i = 1}^{{N}_{1 , 2}^{a}} {q}_{1 , 2}^{a} ( i ) + {\sum }_{i = 1}^{{N}_{1 , 3}^{a}} {q}_{1 , 3}^{a} ( i )$$

$${m}_{0 , 2}^{b} + {\sum }_{i = 1}^{{N}_{0 , 2}^{b}} {q}_{0 , 2}^{b} ( i ) + {\sum }_{i = 1}^{{N}_{1 , 2}^{a}} {q}_{1 , 2}^{a} ( i ) + {\sum }_{i = 1}^{{N}_{2 , 3}^{b}} {q}_{2 , 3}^{b} ( i ) = {m}_{0 , 2}^{a} + {\sum }_{i = 1}^{{N}_{0 , 2}^{a}} {q}_{0 , 2}^{a} ( i ) + {\sum }_{i = 1}^{{N}_{1 , 2}^{b}} {q}_{1 , 2}^{b} ( i ) + {\sum }_{i = 1}^{{N}_{2 , 3}^{a}} {q}_{2 , 3}^{a} ( i )$$

$${m}_{0 , 3}^{b} + {\sum }_{i = 1}^{{N}_{0 , 3}^{b}} {q}_{0 , 3}^{b} ( i ) + {\sum }_{i = 1}^{{N}_{1 , 3}^{a}} {q}_{1 , 3}^{a} ( i ) + {\sum }_{i = 1}^{{N}_{2 , 3}^{a}} {q}_{2 , 3}^{a} ( i ) = {m}_{0 , 3}^{a} + {\sum }_{i = 1}^{{N}_{0 , 3}^{a}} {q}_{0 , 3}^{a} ( i ) + {\sum }_{i = 1}^{{N}_{1 , 3}^{b}} {q}_{1 , 3}^{b} ( i ) + {\sum }_{i = 1}^{{N}_{2 , 3}^{b}} {q}_{2 , 3}^{b} ( i )$$

The following inequalities model constraint (iii):

M_{0,k}^{b}·β_{0,k}^{t,b}(1)−m_{0,k}^{b}≦0

M_{0,k}^{a}·β_{0,k}^{t,a}(1)−m_{0,k}^{a}≦0

m_{0,k}^{x}≦M_{0,k}^{x}−(1−β_{0,k}^{m,x})

m_{0,k}^{x}≧M_{0,k}^{x}·β_{0,k}^{m,x}

Q_{0,k}^{x}(N_{0,k}^{x})·(1−β_{0,k}^{m,y})≦q_{0,k}^{x}(N_{0,k}^{x})∀ k; ε [symbol] k; >0, ∀ x, y ε X, x≠y

To derive the inequalities for constraint (iv), it is referred to FIG. 2. As can be seen from FIG. 2, there are seven cycles of length 3 or 4 within the undirected digraph. These seven cycles describe all price consistencies which may occur during the opening auction. The seven cycles of FIG. 2 are (using the same notation as introduced with regard to FIG. 2):

I. ({0,1}, {1,2},{2,0})

II. ({0,1}, {1,3},{2,0})

III. ({0,2}, {2,3},{3,0})

IV. ({0,1}, {1,2},{2,3}, {3,0})

V. ({0,1}, {1,3},{3,2}, {2,0})

VI. ({0,2}, {2,1},{1,3}, {3,0})

VII. ({1,2}, {2,3},{3,1})

Cycles of length 2 represent a matching within one and the same order book. Price consistency of an order book to itself, however, is trivial. Accordingly, if at least one contract has been executed in each tradable series and each futures combination of a matching path, there needs to be price consistency between the tradable series and futures combination of said matching path.

The price consistency within each matching path may be modelled by two inequalities. Hence, constraint (iv) is modelled by 14 inequalities:

p_{0,1}−p_{0,2}−p_{1,2}≧(U_{0,1}−O_{0,2}−O_{1,2})·(1−s₁)

p_{0,1}−p_{0,2}−p_{1,2}≦(O_{0,1}−U_{0,2}−U_{1,2})·(1−s₁)

p_{0,1}−p_{0,3}−p_{1,3}≧(U_{0,1}−O_{0,3}−O_{1,3})·(1−s₂)

p_{0,1}−p_{0,3}−p_{1,3}≦(O_{0,1}−U_{0,3}−U_{1,3})·(1−s₂.)

p_{0,2}−p_{0,3}−p_{2,3}≧(U_{0,2}−O_{0,3}−O_{2,3})·(1−s₃)

p_{0,2}−p_{0,3}−p_{2,3}≦(O_{0,2}−U_{0,3}−U_{2,3})·(1−s₃)

p_{0,1}−p_{0,2}−p_{1,3}+p_{2,3}≧(U_{0,1}−O_{0,2}−O_{1,3}+U_{2,3})·(1−s₄)

p_{0,1}−p_{0,2}−p_{1,3}+p_{2,3}≦(O_{0,1}−U_{0,2}−U_{1,3}+O_{2,3})·(2−s₄)

p_{0,1}−p_{0,3}−p_{1,2}−p_{2,3}≧(U_{0,1}−O_{0,3}−O_{1,2}−O_{2,3})·(1−s₅)

p_{0,1}−p_{0,3}−p_{1,2}−p_{2,3}≦(O_{0,1}−U_{0,3}−U_{1,2}−U_{2,3})·(1−s₅)

p_{0,2}−p_{0,3}−p_{1,3}+p_{1,2}≧(U_{0,2}−O_{0,3}−O_{1,3}+U_{1,2})·(1−s₆)

p_{0,2}−p_{0,3}−p_{1,3}+p_{1,2}≦(O_{0,2}−U_{0,3}−U_{1,3}+O_{1,2})·(1−s₆)

p_{1,3}−p_{1,2}−p_{2,3}≧(U_{1,3}−O_{1,2}−O_{2,3})·(1−s₇)

p_{1,3}−p_{1,2}−p_{2,3}≦(O_{1,3}−U_{1,2}−U_{2,3})·(1−s₇)

Finally, the following inequalities model constraint (v):

b_{0,k}_{₁}−a_{0,k}_{₂}<aₖ_{₁}_{,k}_{₂}, ∀ k₁, k₂ ε [symbol] k₂>k₁>0

a_{0,k}_{₁}−b_{0,k}_{₂}>bₖ_{₁}_{,k}_{₂}, ∀ i₁, k₂ ε [symbol] k₂>k₁0

a_{1,2}+a_{,23}+a_{0,3}>b_{0,1}

b_{1,2}+b_{2,3}+b_{0,3}<a_{0,1}

a_{0,2}+a_{1,3}−b_{2,3}>b_{0,1}

b_{0,2}+b_{1,3}−a_{2,3}<a_{0,1}

a_{0,3}+a_{1,3}−b_{1,2}>b_{0,2}

b_{0,3}+b_{1,3}−a_{1,2}<a_{0,2}

b_{1,2}+b_{2,3}<a_{1,3}

a_{1,2}+a_{2,3}>b_{1,3}

b_{j,k}<a_{j,k}, ∀ j,k ε [symbol] k>j

These inequalities modelling constraint (v) ensure that none of the order books are crossed at the end of the opening auction, either directly or synthetically.

Describing for the example of futures having six order books step 430 performed by pre-processing module 350 in even more detail, in phase 1 of step 430 an upper bound for the number of executable contracts is determined for each side of each of the six order books. As described with respect to FIG. 2, there are 20 matching paths for each futures enumerated 1 to 20:

| | |
|---|---|
| 1. | ((1,0), (0,1)) |
| 2. | ((2,0), (0,2)) |
| 3. | ((3,0), (0,3)) |
| 4. | ((1,2), (2,1)) |
| 5. | ((1,3), (3,1)) |
| 6. | ((2,3), (3,2)) |
| 7. | ((0,1), (1,2), (2,0)) |
| 8. | ((0,1), (1,3), (3,0)) |
| 9. | ((0,2), (2,1), (1,0)) |
| 10. | ((0,2), (2,3), (3,0)) |
| 11. | ((0,3), (3,1), (1,0)) |
| 12. | ((0,3), (3,2), (2,0)) |
| 13. | ((1,2), (2,3), (3,0)) |
| 14. | ((2,1), (1,3), (3,0)) |
| 15. | ((0,1), (1,2), (2,3), (3,0)) |
| 16. | ((0,1), (1,3), (3,2), (2,0)) |
| 17. | ((0,2), (2,1), (1,3), (3,0)) |
| 18. | ((0,2), (2,3), (3,1), (1,0)) |
| 19. | ((0,3), (3,1), (1,2), (2,0)) |
| 20. | ((0,3), (3,2), (2,1), (1,0)) |

The tradable series labelled with 1 may be associated with the expiration date closest to the date of the current trading day and the tradable series 3 may be associated with the expiration date farthest from the date of the current trading day. The pre-processing module 350 may determine the upper bound for the sum of maximal executable contracts of one side (buy or sell side) of an order book based on matching paths 1 to 5 and disregard the other matching paths. The pre-processing module 350 may consider each of matching paths 1 to 5 separately. Hence, for the determination ‘of the upper bound, the maximal executable volume may be:

$${v}_{j , k}^{x} ( m ) = {\sum }_{l ∈ {T}_{j , k}^{x}}^{ } {v}_{l}^{p} ( m )$$

wherein T_{j,k}^{x} is the set of indexes of the five matching paths for side x of order book (j,k) and vₗ^{p}(m) is the maximal executable volume of matching path l. This maximal volume of executable contracts may be calculated for all 12 sides of the six order books. Following this step, the volume associated with a price level i may be totalled for all order books until the totalled volume exceeds v_{j,k}^{x}(m). Hence, r is minimized subject to

$${\sum }_{i = 1}^{r} {Q}_{j , k}^{x} ( i )$$

is greater than v_{j,k}^{x}(m). All price levels i greater than r are not relevant for the optimization step 440 and thus may be cancelled.

For phase 2 of step 430, the bounds determined in phase 1 may be modified based on price dependencies to obtain more restrictive intervals for the auction price. Specifically, for each price dependency I) to VII) listed above for which at least one contract has been executed in each tradable series and combination due to crossed order books, more restrictive upper and lower bounds for the auction price may be determined.

The new lower bound determined in phase 2 of step 430 may be:

U_{0,1}(m+1)=max(U_{0,1}(m), U_{1,2}(m)+U_{0,2}(m))

Similarly, the new upper bound determined in phase 2 may be:

O_{0,1}(m+1)=min(O_{0,1}(m), O_{1,2}(m)+O_{0,2}(m))

The pre-processing module 350 may further determine at the end of each of phases 1 and 2 of step 430 for each order book whether the respective order book has been amended, i.e. if orders have been cancelled. If the respective order book has been amended, a further iteration is performed. The iterations finally result in modified order books 360-1, 360-2 to 360-I.

In conclusion, the present invention provides a computer system and computer-implemented method for performing an opening auction for a derivative such as futures. Contrary to conventional system and methods, the optimizing module 370 of the present invention determines concurrently the auction price of derivative combinations and the auction price for the tradable series of the same derivative in the opening auction. This results in consistent opening prices at the end of the opening auction, i.e. at the beginning of the continuous trade of the derivative. Hence, the price quality is improved. In addition, the pre-processing module 350 of the present invention may scale down the size of the order books used in the opening auction. This reduces the runtime of the optimizing process performed by the optimizing module 370 and thus shortens the duration of the opening auction.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A computer system for performing an opening auction of a derivative, the system comprising:
an order maintenance module configured to maintain a plurality of order books for said derivative, the plurality of order books comprising a first set of order books and a second set of order books, wherein each order book of the first set comprises bid and ask orders for a specific tradable series of the derivative and wherein each order book of the second set comprises bid and ask orders for a specific combination of two tradable series of the derivative, any such combination being defined as the simultaneous purchase of one specific tradable series and the sale of another tradable series of said derivative, and wherein each bid and ask order is associated with an integer volume of tradable contracts of the derivative; and
an optimizing module operatively coupled to the order maintenance module, the optimizing module being configured to maximize a total volume of executed contracts using integer optimization, the total volume of executed contracts being the sum of the integer volumes associated with contracts executed in said plurality of order books.

2. The computer system of claim 1, wherein all tradable series are sorted by expiration date, and wherein the system further comprises a constraints repository, the constraints repository being configured to provide constraints and being operatively coupled to the optimizing module, the optimizing module being further configured to:
maximize the total volume of executed contracts subject to constraints provided by the constraints repository;
determine for each limit order in the plurality of order books a limit price;
determine a ticksize value of the derivative; and
divide each of the limit prices by said ticksize value.

3. The computer system of claim 2, wherein the constraints comprise:
if a limit price of a limit bid order of an order book is greater than the auction price of the respective order book, restricting an execution of the limit bid order to complete execution;
if a limit price of a limit bid order of an order book is less than the auction price of the respective order book, denying an execution of the limit bid order;
if a limit price of a limit bid order of an order book is equal to the auction price of the respective order book, permitting a partial execution of the limit bid order or restricting an execution of the limit bid order to complete execution or denying an execution of the limit bid order;
if a limit price of a limit ask order of an order book is greater than the auction price of the respective order book, denying an execution of the limit ask order;
if a limit price of a limit ask order of an order book is less than the auction price of the respective order book, restricting an execution of the limit ask order to complete execution;
if a limit price of a limit ask order of an order book is equal to the auction price of the respective order book, permitting a partial execution of the limit ask order.

4. The computer system of claim 3, wherein the constraints further comprise:
for each of the tradable series, the integer volume of executed contracts associated with bid orders of a tradable series equals the integer volume of executed contracts associated with ask orders of the respective tradable series.

5. The computer system of claim 4, wherein the constraints further comprise:
for each order book, executing market orders before limit orders.

6. The computer system of claim 5, wherein the constraints further comprise:
if at least one contract has been executed in each tradable series and each derivative combination of a matching path, ensuring price consistency between the tradable series and derivative combination of said matching path.

7. The computer system of claim 6, wherein the constraints further comprise:
at the end of the opening auction, none of the order books is a crossed order book.

8. The computer system of claim 1, wherein the order maintenance module further comprises a pre-processing module, the pre-processing module being configured to scale down the size of each order book to minimize the runtime of the maximizing action of the optimizing module, and wherein the optimizing module is further configured to maximize the sum of integer volumes associated with contracts executed in the downscaled order books.

9. The computer system of claim 8, wherein the action of scaling down comprises:
for each order book, calculating an upper bound for the volume of executable contracts associated with bid orders;
for each order book, determining a lower bound for a bid price limit based on the respective calculated upper bound for the volume of executable contracts associated with bid orders;
for each order book, cancelling all bid orders of the respective order book associated with a bid price limit less than the respective determined lower bound for the bid price;
for each order book, calculating an upper bound for the volume of executable contracts associated with ask orders;
for each order book, determining an upper bound for an ask price limit based on the respective calculated upper bound for the volume of executable contracts associated with ask orders; and
for each order book, cancelling all ask orders of the respective order book associated with an ask price limit greater than the respective determined upper bound for the ask price.

10. The computer system of claim 9, wherein the action of scaling down further comprises:
for each order book, lowering the determined upper bound for an ask price based on price consistencies implied by crossed order books; and
for each order book, raising the determined lower bound for a bid price based on price consistencies implied by crossed order books.

11. A computer-implemented method for performing an opening auction of a derivative, comprising:
receiving, by an order maintenance module of a computer system, a first and a second order book, the first order book comprising bid orders and ask orders for a first tradable series of said derivative, the second order book comprising bid orders and ask orders for a second tradable series of said derivative;
receiving, by the order maintenance module, a third order book, the third order book comprising bid orders for the first tradable series combined with ask orders for the second tradable series;
wherein each of the bid orders and each of the ask orders in each of the first, second and third order book is associated with an integer volume of tradable contracts of said derivative;
calculating, by a pre-processing module of the computer system, for each of the first, second and third order book an upper bound for the volume of executable contracts associated with bid orders;
calculating, by the pre-processing module, for each of the first, second and third order book an upper bound for the volume of executable contracts associated with ask orders;
providing, by the pre-processing module, modified first, second and third order books by cancelling, for each order book, bid orders based on the calculated upper bound for the volume of executable contracts associated with bid orders of the respective order book and cancelling, for each order book, ask orders based on the calculated upper bound for the volume of executable contracts associated with ask orders of the respective order book;
providing the modified first, second and third order books to an optimizing module of the computer system; and
determining, by the optimizing module, an opening price of each of the first and second tradable series of the derivative using the modified first, second and third order books.

12. The computer-implemented method of claim 11, wherein each of the first tradable series and second tradable series is associated with an expiration date, the first tradable series expiring prior to the second tradable series, and wherein the step of determining an opening price comprises:
maximizing a total volume of executed contracts using integer optimization subject to constraints, the total volume of executed contracts being the sum of the integer volumes associated with contracts executed in said first, second and third modified order books.

13. The computer-implemented method of claim 12, the step of providing first, second and third modified order books comprises:
for each of the first, second and third order book, determining a lower bound for a bid price limit based on the respective calculated upper bound for the volume of executable contracts associated with bid orders;
for each of the first, second and third order book, cancelling all bid orders of the respective order book associated with a bid price limit less than the respective determined lower bound for the bid price;
for each of the first, second and third order book, determining an upper bound for an ask price limit based on the respective calculated upper bound for the volume of executable contracts associated with ask orders; and
for each of the first, second and third order book, cancelling all ask orders of the respective order book associated with a ask price limit greater than the respective determined upper bound for the ask price.

14. The computer-implemented method of claim 13, wherein the step of providing first, second and third modified order books further comprises:
for each of the first, second and third order book, lowering the determined upper bound for an ask price based on price consistencies implied by crossed order books; and
for each of the first, second and third order book, raising the determined lower bound for a bid price based on price consistencies implied by crossed order books.

15. The computer-implemented method of claim 14, wherein the step of determining an opening price further comprises:
determining for each limit order in the first, second and third modified order books a limit price;
determining a ticksize value of the derivative; and
dividing each of the limit prices by said ticksize value.

16. The computer-implemented method of claim 15, wherein the constraints comprise:
if a limit price of a limit bid order of a modified order book is greater than the auction price of the respective modified order book, restricting an execution of the limit bid order to complete execution;
if a limit price of a limit bid order of a modified order book is less than the auction price of the respective modified order book, denying an execution of the limit bid order;
if a limit price of a limit bid order of a modified order book is equal to the auction price of the respective modified order book, permitting a partial execution of the limit bid order or restricting an execution of the limit bid order to complete execution or denying an execution of the limit bid order;
if a limit price of a limit ask order of a modified order book is greater than the auction price of the respective modified order book, denying an execution of the limit ask order;
if a limit price of a limit ask order of a modified order book is less than the auction price of the respective modified order book, restricting an execution of the limit ask order to complete execution;
if a limit price of a limit ask order of a modified order book is equal to the auction price of the respective modified order book, permitting a partial execution of the limit ask order.

17. The computer-implemented method of claim 16, wherein the constraints further comprise:
for each of the tradable series, the integer volume of executed contracts associated with bid orders of a tradable series equals the integer volume of executed contracts associated with ask orders of the respective tradable series.

18. The computer-implemented method of claim 17, wherein the constraints further comprise:
for each modified order book, executing market orders before limit orders.

19. The computer-implemented method of claim 18, wherein the constraints further comprise:
if at least one contract has been executed in each tradable series and each derivative combination of a matching path, ensuring price consistency between the tradable series and derivative combination of said matching path.

20. The computer system of claim 19, wherein the constraints further comprise:
at the end of the opening auction, none of the modified order books is a crossed order book.
